(19) United States
(12) Patent Application Publication
(10) Pub. No.: US 2016/0254565 A1
(43) Pub. Date: Sep. 1, 2016

(54) SECOND BATTERY AND METHOD OF PRODUCING THE SAME

(71) Applicant: Sanyo Electric Co., Ltd., Osaka (JP)

(72) Inventors: Ryoichi Wakimoto, Hyogo (JP); Masakazu Yamada, Hyogo (JP)

(73) Assignee: Sanyo Electric Co., Ltd., Osaka (JP)

(21) Appl. No.: 15/048,151

(22) Filed: Feb. 19, 2016

(30) Foreign Application Priority Data
Feb. 27, 2015 (JP) 2015-038616

(51) Int. Cl. H01M 10/04; B23K 11/11; B23K 11/30; H01M 2/02; H01M 2/30

(52) U.S. Cl. CPC H01M 10/0431; H01M 2/0237; H01M 2/30; B23K 11/30; B23K 11/115; H01M 2220/20

(57) ABSTRACT

A method of producing a second battery includes performing resistance welding to melt a projection formed on a connecting surface of a junction of a negative-electrode current collector and an exposed negative-electrode-core portion formed of stacked layers and form a weld nugget such that the section of the weld nugget that is perpendicular to the direction in which the layers of the exposed negative-electrode-core portion are stacked is oblong, while the projection is in contact with the outermost surface of the exposed negative-electrode-core portion in the direction in which the layers are stacked.

### CROSS REFERENCE TO RELATED APPLICATIONS

The present invention application claims priority to Japanese Patent Application No. 2015-038616 filed in the Japan Patent Office on Feb. 27, 2015, the entire contents of which are incorporated herein by reference.

### BACKGROUND OF THE INVENTION

1. Field of the Invention

The present invention is related to the structure of a current collector of a secondary battery.

2. Description of Related Art

Alkali secondary batteries and non-aqueous electrolyte secondary batteries are used in power sources for driving electric vehicles (EVs) and hybrid electric vehicles (HEVs or PHEVs). The secondary batteries used as batteries installed in vehicles, such as EVs, HEVs, or PHEVs, are required to have a high capacity and high output characteristics. Accordingly, in many cases, these secondary batteries are used in the form of batteries connected in series or in parallel.

In a secondary battery, a battery case is formed of an exterior body having an opening and a sealing plate to seal the opening. An electrode body including a positive-electrode sheet, a negative-electrode sheet, a separator, and an electrolytic solution are contained in the battery case. A positive terminal and a negative terminal are secured to the sealing plate. The positive terminal is electrically connected to the positive-electrode sheet via a positive-electrode current collector. The negative terminal is electrically connected to the negative-electrode sheet via a negative-electrode current collector.

The positive-electrode sheet includes a metallic positive-electrode core and a positive electrode active material mixture layer formed on the surface of the positive-electrode core. The positive-electrode core includes an exposed positive-electrode-core portion on which the positive electrode active material mixture layer is not formed. The positive-electrode current collector is connected to the exposed positive-electrode-core portion. The negative-electrode sheet includes a metallic negative-electrode core and a negative electrode active material mixture layer formed on the surface of the negative-electrode core. The negative-electrode core includes an exposed negative-electrode-core portion on which the negative electrode active material mixture layer is not formed. The negative-electrode current collector is connected to the exposed negative-electrode-core portion. The exposed core portions and the current collectors are preferably connected by resistance welding, which allows the welding to be performed in a short period and achieves a high welding quality.

For example, Japanese Published Unexamined Patent Application No. 2009-176482 (Patent Document 1) discloses a technique that connects a current collector and an exposed core portion by resistance welding.

### BRIEF SUMMARY OF THE INVENTION

An object of the present invention is to provide a secondary battery whose junction between a current collector member and an exposed core portion is reliable, and a method of producing the secondary battery.

A method of producing a secondary battery according to one aspect of the present invention is a method of producing a secondary battery including a flat electrode body including a positive-electrode sheet and a negative-electrode sheet, and a battery case containing the electrode body therein. At least one of the positive-electrode sheet and the negative-electrode sheet includes a core and an active material mixture layer formed on the core, the core includes an exposed core portion at which the core is exposed, the exposed core portion is connected to a current collector member, and the current collector member includes a junction connected to the exposed core portion and a connecting surface provided on the junction such that the connecting surface faces the exposed core portion. The method includes performing resistance welding to melt the projection and the exposed core portion and form a weld nugget, while a projection is in contact with an outer surface of the exposed core portion formed of stacked layers. The projection is formed on the connecting surface of the current collector member before the current collector member is connected to the exposed core portion. A section of the weld nugget that is perpendicular to a direction in which the layers of the exposed core portion are stacked is oblong, when an area of the section of the weld nugget is at a maximum.

Thus, the projection is formed on the connecting surface of the current collector member, and the resistance welding is performed to melt the projection and the exposed core portion and form the weld nugget such that the section of the formed weld nugget is oblong. The weld nugget with a large sectional area is thereby efficiently formed. Accordingly, the current collector member and the exposed core portion are more firmly connected. This structure enables the sectional area of the weld nugget to be increased more efficiently than when the section of the weld nugget is in the form of a perfect circle and the sectional area of the weld nugget is increased.

The “current collector member” is a conductive member, such as a current collector or a current collector support, that is connected to the exposed core portion by welding. The current collector is directly connected to the exposed core portion and electrically connected to an external terminal without the intermediation of the exposed core portion. When the current collector support is used, the current collector is disposed on one outer surface of the exposed core portion in the direction in which the layers of the exposed core portion are stacked and the current collector support is disposed on the other outer surface. In the present invention, the current collector support is not essential. When the current collector and the current collector support are used, it is sufficient to provide at least one of the current collector and the current collector support with the projection. When the current collector support is not used, the current collector may be provided with the projection.

The current collector member is preferably made of a metal. The current collector member may be made of, for example, aluminum, an aluminum alloy, copper, a copper alloy, iron, or nickel. The current collector may be made of a different material from the material of which the current collector support is made.

The method by which the exposed core portion is formed of the stacked layers is not particularly limited. The exposed core portion may be formed of the stacked layers in a manner in which a long positive-electrode sheet including an exposed positive-electrode-core portion at its end in the width direction and a long negative-electrode sheet including an exposed negative-electrode-core portion at its end in the width direction are wound with a separator interposed therebetween and hence the exposed positive-electrode-core portion and the exposed negative-electrode-core portion are wound. Alternatively, the exposed positive-electrode-core portion and the exposed negative-electrode-core portion may be formed of the stacked layers in a manner in which plural positive-electrode sheets each including the exposed positive-electrode-core portion and plural negative-electrode sheets each including the exposed negative-electrode-core portion are stacked.

The projection formed on the connecting surface of the current collector member is melted by the resistance welding and deforms or disappears.

A border between a region in which the active material mixture layer is formed and a region in which the active material mixture layer is not formed is preferably established in the core to which the current collector member is connected, and a ratio of the length of the section of the weld nugget in a direction in line with the border to the width of the section of the weld nugget in a direction perpendicular to the border is preferably 1.5 or more.

A border between a region in which the active material mixture layer is formed and a region in which the active material mixture layer is not formed is preferably established in the core to which the current collector member is connected, and a ratio of the width of the junction to the width of the section of the weld nugget in the direction perpendicular to the border is preferably 1.5 or more.

The shape of the projection in plan view is preferably oblong.

The “shape of the projection in plan view” means the shape of the projection when the projection is viewed in the direction perpendicular to the connecting surface of the current collector member.

A border between a region in which the active material mixture layer is formed and a region in which the active material mixture layer is not formed is preferably established in the core to which the current collector member is connected, and in the step of the resistance welding, the projection is preferably disposed such that the major axis thereof extends in a direction in line with the border.

The electrode body is preferably a wound electrode body obtained by winding the positive-electrode sheet and the negative-electrode sheet with the separator interposed therebetween, and in the step of the resistance welding, the projection is preferably disposed such that the major axis thereof extends in a direction perpendicular to a direction in which a winding axis of the wound electrode body extends.

At least two of the projections are preferably formed on the connecting surface, and in the step of the resistance welding, the resistance welding is preferably performed to melt the at least two of the projections and the exposed core portion and form the weld nugget, while the at least two of projections are in contact with the outer surface of the exposed core portion formed of the stacked layers.

In the step of the resistance welding, the at least two of the projections are preferably arranged in a direction in line with a border between a region in which the active material mixture layer is formed and a region in which the active material mixture layer is not formed. The border is established in the core.

The electrode body is preferably a wound electrode body obtained by winding the positive-electrode sheet and the negative-electrode sheet with the separator interposed therebetween, and in the step of the resistance welding, the at least two of the projections are preferably arranged in a direction perpendicular to a direction in which a winding axis of the wound electrode body extends.

Before the step of the resistance welding, a recess is preferably formed on the outer surface of the current collector member opposite the connecting surface at a position corresponding to the projection.

Before the step of the resistance welding, a through hole is preferably formed at the center of the projection of the current collector member.

A secondary battery according to one aspect of the present invention includes a wound electrode body obtained by winding a positive-electrode sheet and a negative-electrode sheet with a separator interposed therebetween, an exterior body that has an opening and contains the wound electrode body, a sealing plate that seals the opening, and a positive terminal and a negative terminal that are secured to the sealing plate. At least one of the positive-electrode sheet and the negative-electrode sheet include a core and an active material mixture layer formed on the core. The core includes an exposed core portion at which the core is exposed. The exposed core portion is connected to a current collector member. The current collector member includes a junction connected to the exposed core portion. The current collector member is connected to an outer surface of the exposed core portion formed of stacked layers. A weld nugget is formed at the junction between the current collector member and the exposed core portion. A section of the weld nugget that is perpendicular to a direction in which the layers of the exposed core portion are stacked is oblong, when an area of the section of the weld nugget is at a maximum, and the width of the section of the weld nugget in a direction in which a winding axis of the wound electrode body extends is smaller than the width of the junction in the direction in which the winding axis extends.

Such a structure of the secondary battery enables the weld nugget to be efficiently formed with a large sectional area and allows the current collector member and the exposed core portion to be more firmly connected. In addition, this structure enables the battery to be reliable such that a part of the electrode body at which electricity is stored is inhibited from being damaged due to molten metallic particles generated when the current collector member and the exposed core portion are welded. The method of welding the current collector member and the exposed core portion is not particularly limited and may be resistance welding or ultrasonic welding. The resistance welding is however preferably used. A projection is preferably formed on the current collector member, and the resistance welding is preferably performed with the projection in contact with the exposed core portion.

A ratio of the length of the section of the weld nugget in a direction perpendicular to the direction in which the winding axis extends to the width of the section of the weld nugget in the direction in which the winding axis extends is preferably 1.5 or more. A ratio of the width of the junction in the direction in which the winding axis extends to the width of the section of the weld nugget in the direction in which the winding axis extends is preferably 1.5 or more.

The present invention can provide a secondary battery whose junction between a current collector member and an exposed core portion is reliable, and a method of producing the secondary battery.

### BRIEF DESCRIPTION OF THE SEVERAL VIEWS OF THE DRAWINGS

FIG. 1A shows the section of a secondary battery of an embodiment.

FIG. 1B shows a section along the line IB-IB in FIG. 1A.

FIG. 2 shows a surface of a sealing plate on the battery interior side, to which a positive-electrode current collector and a negative-electrode current collector are attached.

FIG. 3 is a plan view of the positive-electrode current collector before a bending process.

FIG. 4 is a plan view of the negative-electrode current collector before the bending process.

FIG. 5A is a plan view of the junction on the connecting surface side of the negative-electrode current collector.

FIG. 5B is a section along the line VB-VB in FIG. 5A.

FIG. 6 shows a state where the negative-electrode current collector is disposed on the outer surface of the exposed negative-electrode-core portion formed of stacked layers.

FIG. 7 shows a state where the negative-electrode current collector and the exposed negative-electrode-core portion formed of the stacked layers are put between a pair of resistance welding electrodes.

FIG. 8 shows a state of a weld nugget formed by resistance welding.

FIG. 9 is a section, near a welded junction, that is perpendicular to the direction in which the layers of the exposed negative-electrode-core portion are stacked.

FIG. 10 shows a resistance welding process in a modification.

FIG. 11 shows a resistance welding process in a modification.

FIG. 12 shows a resistance welding process in a modification.

FIG. 13A is a plan view of the junction on the connecting surface side of a current collector used in a modification.

FIG. 13B is a sectional view along the line XIIIB-XIIIB in FIG. 13A.

FIG. 14 is a diagram of a secondary battery in a modification that corresponds to FIG. 9.

FIG. 15 is a diagram of a current collector in which insulator spacers are disposed on its connecting surface.

FIG. 16 is a diagram of a current collector in which an insulator spacer is disposed on its connecting surface.

FIG. 17 is a sectional view along the line XVII-XVII in FIG. 16.

FIG. 18 shows a resistance welding process in a modification.

FIGS. 19A to 19I show the shape of a projection that is oblong in plan view.

### DETAILED DESCRIPTION OF THE INVENTION

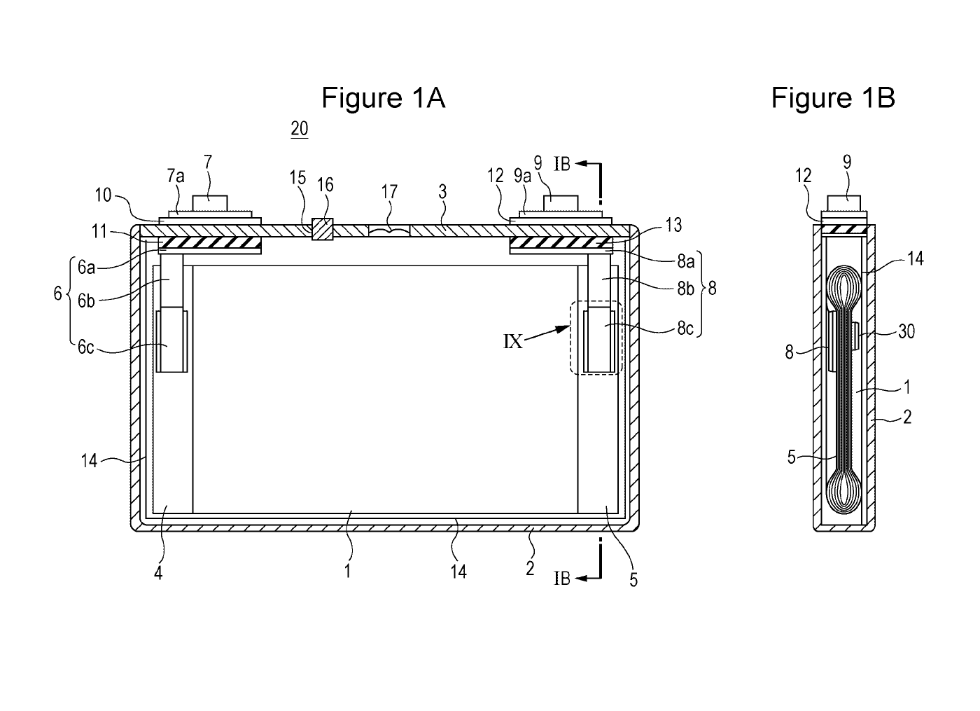

The structure of a square-shaped secondary battery 20 in an embodiment will be described with reference to FIG. 1. The present invention, however, is not limited to the embodiment described below.

As shown in FIG. 1, the square-shaped secondary battery 20 includes a square-shaped exterior body 2 having an opening at its upper part and a sealing plate 3 that seals the opening. The square-shaped exterior body 2 and the sealing plate 3 constitute a battery case. The square-shaped exterior body 2 and the sealing plate 3 are preferably made of a metal and may be made of, for example, aluminum or an aluminum alloy. The square-shaped exterior body 2 contains an electrolyte and a wound electrode body 1 that is flat and obtained by winding a positive-electrode sheet and a negative-electrode sheet with a separator interposed therebetween (these components are not shown in the figure). In the positive-electrode sheet, a positive electrode active material mixture layer containing a positive electrode active material is formed on a metallic positive-electrode core. At an end of the positive-electrode sheet in the width direction, an exposed positive-electrode-core portion 4 at which the positive-electrode core is exposed is formed in the longitudinal direction. An aluminum foil or an aluminum alloy foil is preferably used as the positive-electrode core. In the negative-electrode sheet, a negative electrode active material mixture layer containing a negative electrode active material is formed on a metallic negative-electrode core. At an end of the negative-electrode sheet in the width direction, an exposed negative-electrode-core portion 5 at which the negative-electrode core is exposed is formed in the longitudinal direction. A copper foil or a copper alloy foil is preferably used as the negative-electrode core.

At one end of the wound electrode body 1 in the direction in which a winding axis extends, the exposed positive-electrode-core portion 4 is formed by being wound. The exposed positive-electrode-core portion 4 is wound so that the exposed positive-electrode-core portion 4 is formed of stacked layers. One of the outermost surfaces of the exposed positive-electrode-core portion 4 in the direction in which the layers are stacked is connected to a positive-electrode current collector 6. A positive terminal 7 is electrically connected to the positive-electrode current collector 6. On another outermost surface of the exposed positive-electrode-core portion 4 in the direction in which the layers are stacked, a positive-electrode current collector support is disposed; this outermost surface is on the side opposite the surface on which the positive-electrode current collector 6 is disposed. The positive-electrode current collector support is not essential and can be omitted.

At the other end of the wound electrode body 1 in the direction in which the winding axis extends, the exposed negative-electrode-core portion 5 is formed by being wound. The exposed negative-electrode-core portion 5 is wound so that the exposed negative-electrode-core portion 5 is formed of stacked layers. One of the outermost surfaces of the exposed negative-electrode-core portion 5 in the direction in which the layers are stacked is connected to a negative-electrode current collector 8. A negative terminal 9 is electrically connected to the negative-electrode current collector 8. On another outermost surface of the exposed negative-electrode-core portion 5 in the direction in which the layers are stacked, a negative-electrode current collector support 30 is disposed; this outermost surface is on the side opposite the surface on which the negative-electrode current collector 8 is disposed. The positive-electrode current collector support 30 is not essential and can be omitted.

The positive terminal 7 is secured to a sealing plate 3 with a gasket 10 interposed therebetween. The positive-electrode current collector 6 is secured to a sealing plate 3 with an insulator 11 interposed therebetween. The negative terminal 9 is secured to the sealing plate 3 with a gasket 12 interposed therebetween. The negative-electrode current collector 8 is secured to the sealing plate 3 with an insulator 13 interposed therebetween. The gasket 10 and the gasket 12 are disposed between the sealing plate 3 and the respective terminals. The insulator 11 and the insulator 13 are disposed between the sealing plate 3 and the respective current collectors. The positive terminal 7 includes a flange 7a. The negative terminal 9 includes a flange 9a. The wound electrode body 1 is covered by an insulation seat 14 and contained in the square-shaped exterior body 2. The insulation seat 14 covers the wound electrode body 1 and is disposed between the wound electrode body 1 and the square-shaped exterior body 2. The sealing plate 3 is connected to the periphery of an opening of the square-shaped exterior body 2 by welding such as laser welding. The sealing plate 3 includes an electrolytic solution injecting hole 15. The electrolytic solution injecting hole 15 is sealed by a sealing plug 16 after injection. A gas exhausting valve 17 through which a gas is exhausted when the pressure of the interior of the battery becomes high is formed on the sealing plate 3.

A method of producing the wound electrode body 1 will now be described. The positive-electrode sheet is made in the following manner. A positive-electrode mixture containing lithium cobalt oxide (LiCoO₂) as an example of the positive electrode active material is applied to both surfaces of a rectangular aluminum foil with a thickness of 15 μm as the positive-electrode core so that the positive electrode active material mixture layer is formed, and the exposed positive-electrode-core portion on which the positive electrode active material mixture is not formed within a predetermined width is formed at one short side. The negative-electrode sheet is made in the following manner. A negative-electrode mixture containing natural graphite powder as an example of the negative electrode active material is applied to both surfaces of a rectangular copper foil with a thickness of 8 μm as the negative-electrode core so that the negative electrode active material mixture layer is formed, and the exposed negative-electrode-core portion on which the negative electrode active material mixture is not formed within a predetermined width is formed at one short side.

A porous separator made of polyethylene is put between the positive-electrode sheet and the negative-electrode sheet thus obtained such that the exposed positive-electrode-core portion and the exposed negative-electrode-core portion do not overlap the opposing active material mixture layers of electrodes. The sheets and the separator are wound and pressed, so that the wound electrode body 1 that is flat is obtained. In the wound electrode body 1, a stacked aluminum foil portion (exposed positive-electrode-core portion 4) is formed at one end thereof and a stacked copper foil portion (exposed negative-electrode-core portion 5) is formed at the other end thereof.

A state of the positive-electrode current collector 6 and the negative-electrode current collector 8 attached to the sealing plate 3 will now be described.

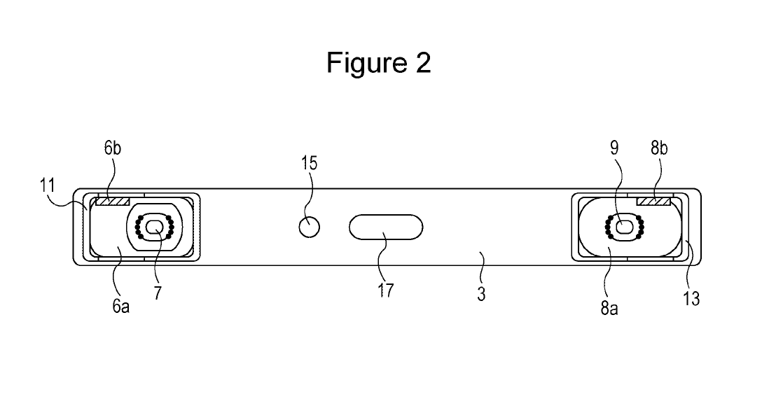

As shown in FIG. 1 and FIG. 2, on one end side of the sealing plate 3 in the longitudinal direction, the gasket 10 is disposed on the battery exterior side of the sealing plate 3 and the insulator 11 is disposed on the battery interior side of the sealing plate 3. The positive terminal 7 is disposed on the gasket 10. The positive-electrode current collector 6 is disposed on the lower surface of the insulator 11. The gasket 10, the sealing plate 3, the insulator 11, and the positive-electrode current collector 6 have a through hole formed therein. The positive terminal 7 is inserted into the through holes from the battery exterior side and the end of the positive terminal 7 is caulked, so that the positive terminal 7, the gasket 10, the sealing plate 3, the insulator 11, and the positive-electrode current collector 6 are integrally secured.

The positive-electrode current collector 6 includes a plate-shaped terminal junction 6a that is disposed between the sealing plate 3 and the wound electrode body 1 and connected to the positive terminal 7, and a lead portion 6b extending from the end of the terminal junction 6a toward the wound electrode body 1, and a junction 6c that is located on the end side of the lead portion 6b and connected to the exposed positive-electrode-core portion 4. The terminal junction 6a is disposed in parallel with the sealing plate 3.

On the other end side of the sealing plate 3 in the longitudinal direction, the gasket 12 is disposed on the battery exterior side of the sealing plate 3 and the insulator 13 is disposed on the battery interior side of the sealing plate 3. The negative terminal 9 is disposed on the gasket 12. The negative-electrode current collector 8 is disposed on the lower surface of the insulator 13. The gasket 12, the sealing plate 3, the insulator 13, and the negative-electrode current collector 8 have a through hole formed therein. The negative terminal 9 is inserted into the through holes from the battery exterior side and the end of the negative terminal 9 is caulked, so that the negative terminal 9, the gasket 12, the sealing plate 3, the insulator 13, and the negative-electrode current collector 8 are integrally secured.

The negative-electrode current collector 8 includes a plate-shaped terminal junction 8a that is disposed between the sealing plate 3 and the wound electrode body 1 and connected to the negative terminal 9, and a lead portion 8b extending from the end of the terminal junction 8a toward the wound electrode body 1, and a junction 8c that is located on the end side of the lead portion 8b and connected to the exposed negative-electrode-core portion 5. The terminal junction 8a is disposed in parallel with the sealing plate 3.

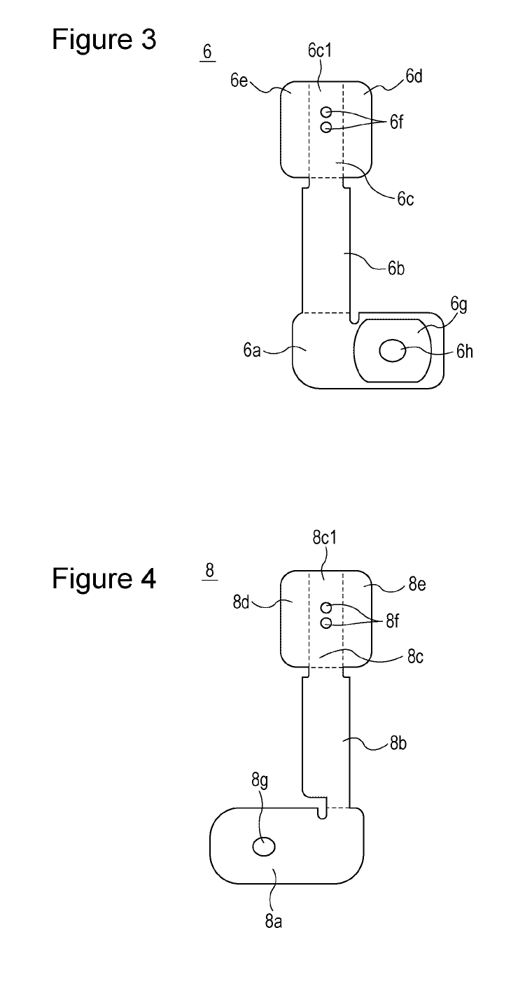

The positive-electrode current collector 6 and the negative-electrode current collector 8 will now be described. FIG. 3 is a plan view of the positive-electrode current collector 6 on the side that faces the wound electrode body 1 before a bending process. The positive-electrode current collector 6 includes the terminal junction 6a, the lead portion 6b, and the junction 6c. The lead portion 6b is bent out of the page with respect to the terminal junction 6a. A portion of the junction 6c on one end side (right hand side in the figure) in the width direction is bent into the page so that a first bent portion 6d is formed. A portion of the junction 6c on the other end side (left hand side in the figure) in the width direction is bent into the page so that a second bent portion 6e is formed. The junction 6c includes a connecting surface 6c1 facing the exposed positive-electrode-core portion 4. Two projections 6f are formed on the connecting surface 6c1.

The terminal junction 6a of the positive-electrode current collector 6 includes a thin portion 6g. The thin portion 6g is formed so as to be thinner than other portions of the terminal junction 6a. A through hole 6h is formed in the thin portion 6g. Accordingly, the end of the positive terminal 7 is secured on the thin portion 6g by means of caulking.

The positive-electrode current collector 6 is preferably made of aluminum or an aluminum alloy.

FIG. 4 is a plan view of the negative-electrode current collector 8 on the side that faces the wound electrode body 1 before a bending process. The negative-electrode current collector 8 includes the terminal junction 8a, the lead portion 8b, and the junction 8c. The lead portion 8b is bent out of the page with respect to the terminal junction 8a. A portion of the junction 8c on one end side (left hand side in the figure) in the width direction is bent into the page so that a first bent portion 8d is formed. A portion of the junction 8c on the other end side (right hand side in the figure) in the width direction is bent into the page so that a second bent portion 8e is formed. The junction 8c includes a connecting surface 8c1 facing the exposed negative-electrode-core portion 5. Two projections 8f are formed on the connecting surface 8c1.

A through hole 8g is formed in the terminal junction 8a of the negative-electrode current collector 8. The negative-electrode current collector 8 is preferably made of copper or a copper alloy. The negative-electrode current collector 8 may be plated with, for example, Ni.

The bending process for the positive-electrode current collector 6 and the negative-electrode current collector 8 may be performed before the collectors are secured to the sealing plate 3 or after the collectors are secured to the sealing plate 3. For example, the bending process can be performed on the first bent portions 6d, 8d and the second bent portions 6e, 8e with respect to the junction 6c, 8c before the current collectors 6, 8 are secured to the sealing plate 3, and the bending process can be performed on the lead portions 6b, 8b with respect to the terminal junctions 6a, 8a after the current collectors 6, 8 are secured to the sealing plate 3. The bending process can also be performed on the lead portions 6b, 8b with respect to the terminal junctions 6a, 8a before the current collectors 6, 8 are secured to the sealing plate 3. The bending process can also be performed on the first bent portions 6d, 8d and the second bent portions 6e, 8e with respect to the junctions 6c, 8c after the current collectors 6, 8 are secured to the sealing plate 3. The current collector may be configured such that neither the first bent portion nor the second bent portion is formed.

A method of attaching the positive-electrode current collector 6 and the negative-electrode current collector 8 to the wound electrode body 1 will now be described. The positive-electrode current collector 6 can be attached to the wound electrode body 1 in substantially the same manner as in the negative-electrode current collector 8. Accordingly, the negative electrode side will be described below as an example of the attaching method.

The shape of the junction 8c of the negative-electrode current collector 8 will be first described.

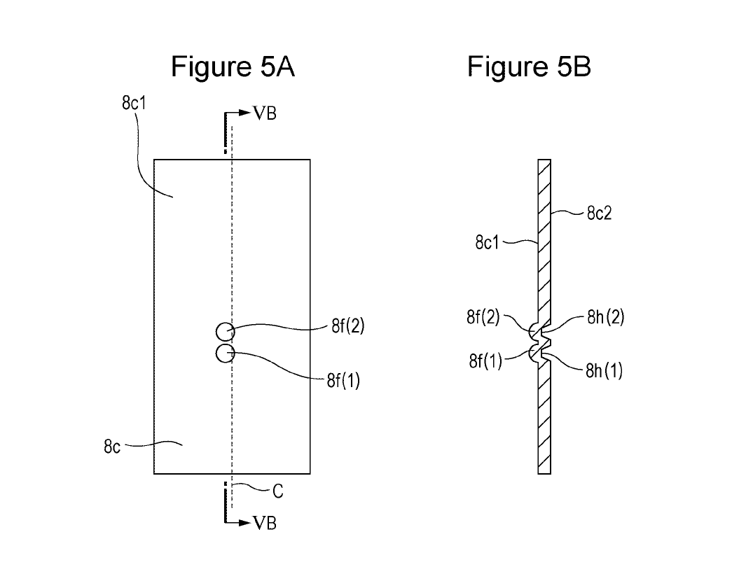

FIG. 5A is an enlarged plan view of the junction 8c of the negative-electrode current collector 8 and shows the surface on the side of the connecting surface 8c1. FIG. 5B is a sectional view along the line VB-VB in the FIG. 5A. The left hand side in the FIG. 5A is a central side (side of a part at which electricity is stored) in a direction in which the winding axis of the wound electrode body 1 extends. The right hand side in the FIG. 5A is an end side of the exposed negative-electrode-core portion 5 that is wound.

The two projections 8f(1), 8f(2) are formed on the connecting surface 8c1 (surface on the near side in the figure) that is disposed such that the surface faces the exposed negative-electrode-core portion 5. The two projections 8f are formed so as to be longitudinally arranged. More specifically, the two projections 8f are arranged in the direction in line with a border between a region in which the negative electrode active material mixture layer is formed and a region in which the negative electrode active material mixture layer is not formed, in the negative-electrode core. In the wound electrode body 1, the two projections 8f are arranged in the direction perpendicular to the direction in which the winding axis extends.

The two projections 8f are formed at positions apart from the center line C in the width direction of the connecting surface 8c1 toward the center of the wound electrode body 1 in the direction in which the winding axis of the wound electrode body 1 extends. This structure enables the end of the exposed core portion to be prevented from melting. Accordingly, scattering of molten metallic particles can be prevented.

Recesses 8h(1), 8h(2) are formed at positions corresponding to the projection 8f(1), 8f(2) on an outer surface 8c2 of the junction 8c opposite the connecting surface 8c1. This structure enables the projections 8f to be readily formed on the junction 8c.

A process of connecting the junction 8c and the exposed negative-electrode-core portion 5 will now be described.

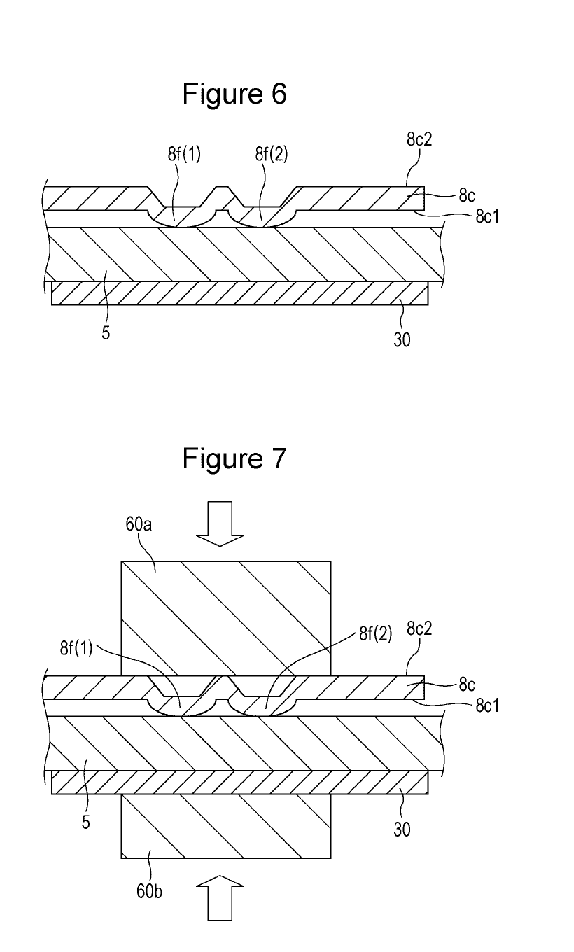

As shown in FIG. 6, in the wound electrode body 1 made in the above manner, the junction 8c of the negative-electrode current collector 8 is disposed on one of the outermost surfaces of the exposed negative-electrode-core portion 5 in the direction in which the layers are stacked. At this time, the connecting surface 8c1 is arranged so as to face the exposed negative-electrode-core portion 5 and the projections 8f(1), 8f(2) are brought into contact with the outermost surface of the exposed negative-electrode-core portion 5. The negative-electrode current collector support 30 is disposed on another outermost surface of the exposed negative-electrode-core portion 5 in the direction in which the layers are stacked. The negative-electrode current collector 8 and the negative-electrode current collector support 30 can also be made by performing the bending process on a metallic plate. The negative-electrode current collector support 30 is not necessarily used.

As shown in FIG. 7, a resistance welding electrode 60a is then disposed on the outer surface 8c2 of the junction 8c. At this time, the resistance welding electrode 60a is disposed at a position corresponding to the two projections 8f(1), 8f(2). A resistance welding electrode 60b is disposed on the outer surface of the negative-electrode current collector support 30. The resistance welding electrode 60b is disposed at a position corresponding to the two projections 8f(1), 8f(2). The projection 8f(1) and the projection 8f(2) of the negative-electrode current collector 8, the exposed negative-electrode-core portion 5 formed of the stacked layers, and the negative-electrode current collector support 30 are held between the pair of the resistance welding electrodes 60a, 60b. In this condition, resistance welding is performed by applying a voltage to the pair of resistance welding electrodes 60a, 60b and causing a resistance welding current to flow. The size of the surface of the resistance welding electrode 60a facing the outer surface 8c2 of the junction 8c is preferably the extent that the two projections 6f(1), 6f(2) are within the surface of the resistance welding electrode 60a when viewed in the direction perpendicular to the outer surface 8c2.

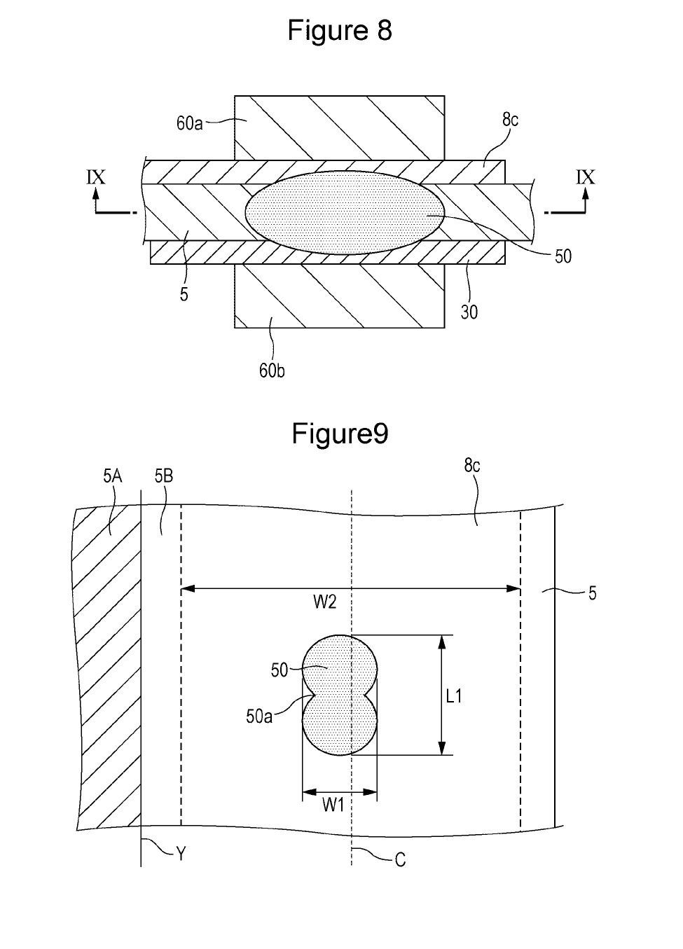

As shown in FIG. 8, the resistance welding causes the projection 8f(1), the projection 8f(2), and the exposed negative-electrode-core portion 5 formed of the stacked layers to be melted, thereby forming a weld nugget 50.

FIG. 9 shows the section that is perpendicular to the direction in which the layers of the exposed negative-electrode-core portion 5 are stacked, when the area of the section of the weld nugget 50 is at its maximum, near a portion (portion IX in FIG. 1A) at which the negative-electrode current collector 8 and the exposed negative-electrode-core portion 5 are welded. FIG. 9 corresponds to a sectional view along the line IV-IV in FIG. 8.

As shown in FIG. 9, the length L1 of the weld nugget 50 in the direction in line with Y (direction perpendicular to the direction in which the winding axis of the wound electrode body 1 extends) is longer than the width W1 of the weld nugget 50 in the direction perpendicular to Y (direction parallel with the direction in which the winding axis of the wound electrode body 1 extends), where Y represents the border of the negative-electrode sheet between a region 5A in which the negative electrode active material mixture layer is formed and a region 5B in which the negative electrode active material mixture layer is not formed. The width W1 of the weld nugget is smaller than the width W2 of the junction 8c of the negative-electrode current collector 8 in the direction perpendicular to the border Y (direction parallel with the direction in which the winding axis of the wound electrode body 1 extends). The center of the weld nugget 50 in the width direction is slightly apart from the center line C in the width direction of the junction 8c of the negative-electrode current collector 8 toward the center of the wound electrode body 1. At a central portion of the weld nugget 50 in the direction in line with the border Y, a narrow part 50a having a small width is formed.

When a projection that is perfectly circular in plan view is formed on the connecting surface of a current collector and a weld nugget is formed with the projection, a large energy is required to increase the size of the weld nugget when welding, and the welding may not efficiently be performed. The welding with a large energy may cause molten metallic particles to scatter. In contrast, when at least two projections are formed on the connecting surface of the current collector and the weld nugget is formed by melting the at least two projections and the exposed core portion as described above, the size of the weld nugget can be more efficiently increased.

The section of the weld nugget that is perpendicular to the direction in which the layers of the exposed core portion are stacked is preferably oblong. When a perfectly circular projection is formed on the connecting surface of a current collector and a weld nugget is formed with the projection, the section of the weld nugget is substantially perfectly circular. When the section of the weld nugget is oblong, the detachment of a portion at which the current collector and the exposed core portion are welded and the breakage of a portion near the welded portion of the exposed core portion can be suppressed more than when the section of the weld nugget is substantially perfectly circular, even though forth is applied in the direction in which the current collector is rotated about the weld nugget with respect to the exposed core portion.

A preferable oblong shape is that the length L1 of the weld nugget 50 in the direction in line with the border Y is larger than the width W1 of the weld nugget 50 in the direction perpendicular to the border Y. This enables an increase in distance between the weld nugget 50 and the part of the wound electrode body 1 at which electricity is stored (part at which the positive electrode active material mixture layer of the positive-electrode sheet and the negative electrode active material mixture layer of the negative-electrode sheet are stacked), even when the section of the weld nugget 50 is oblong. Accordingly, the part of the wound electrode body 1 at which electricity is stored is inhibited from being damaged due to molten metallic particles when welding.

The length L1 and the width W1 of the weld nugget 50 preferably satisfy the relationship L1/W1≧1.5, more preferably L1/W1≧2. This enables the part of the wound electrode body 1 at which electricity is stored to be strongly inhibited from being damaged due to molten metallic particles when welding.

The width W2 of the junction 8c is preferably larger than the width W1 of the weld nugget 50. This enables the part of the wound electrode body 1 at which electricity is stored to be strongly inhibited from being damaged due to molten metallic particles when welding. The width W1 of the weld nugget 50 and the width W2 of the junction 8c preferably satisfy the relationship W2/W1≧1.5, more preferably W2/W1≧2.

At a central portion of the weld nugget 50 in the direction in line with the border Y, the narrow part 50a having a small width is formed so that the width of the weld nugget 50 can be inhibited from increasing. Accordingly, the part of the wound electrode body 1 at which electricity is stored is strongly inhibited from being damaged due to molten metallic particles when welding.

### Assembly of Secondary Battery

On the positive electrode side, the positive-electrode current collector 6 and the positive-electrode current collector support are attached to the exposed positive-electrode-core portion 4 in the same manner as that on the negative electrode side, so that the wound electrode body 1 is secured to the sealing plate 3 with the positive-electrode current collector 6 and the negative-electrode current collector 8 interposed therebetween.

The wound electrode body 1 connected to the positive-electrode current collector 6 and the negative-electrode current collector 8 is then disposed in the interior of an insulation seat 14 that is bent into the form of a box. In this state, the wound electrode body 1 and the insulation seat 14 are inserted into the square-shaped exterior body 2. A junction between the sealing plate 3 and the square-shaped exterior body 2 is welded by laser welding to seal the opening of the square-shaped exterior body 2. A non-aqueous electrolytic solution is poured through the electrolytic solution injecting hole 15 provided in the sealing plate 3. The electrolytic solution injecting hole 15 is sealed by the sealing plug 16, so that the square-shaped secondary battery 20 is assembled.

### Modification 1

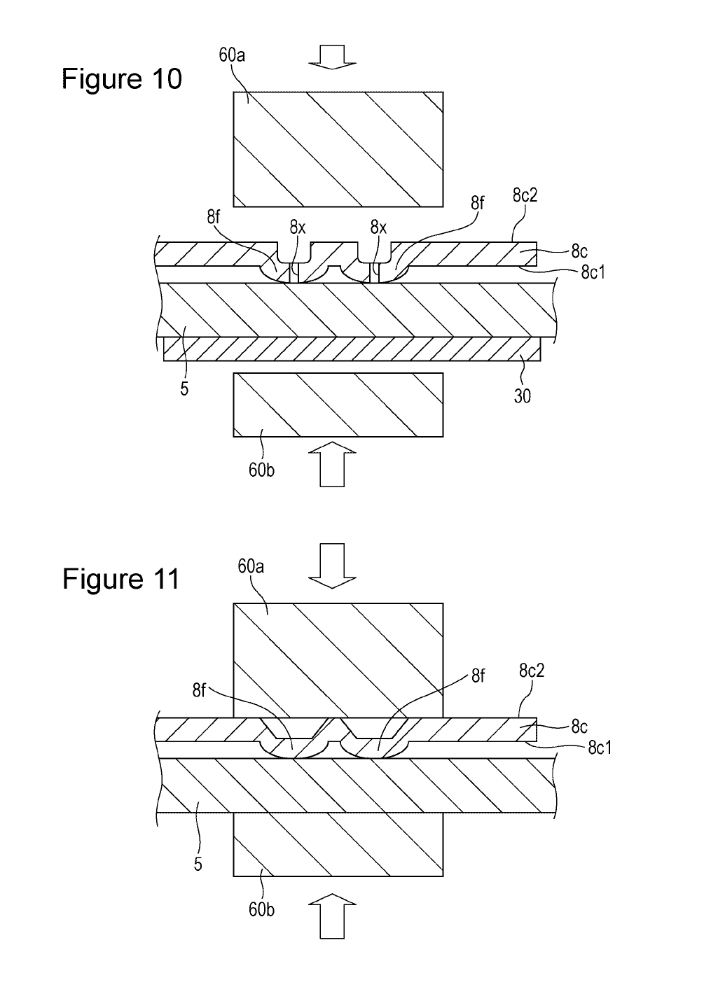

As shown in FIG. 10, through holes 8x can be provided in the central portions of the two projections 8f formed on the junction 8c. The resistance welding can be performed with the negative-electrode current collector 8 in the above manner. The through hole provided in each of the projections of the current collector member enables the projections to be prevented from being crushed when the resistance welding electrodes press the junction, so that high quality welding can be achieved. This is effective particularly when the junctions on which the projections are provided are made of aluminum or an aluminum alloy and are relatively soft.

### Modification 2

As shown in FIG. 11, the resistance welding can be performed without using the negative-electrode current collector support 30 (or the positive-electrode current collector support).

### Modification 3

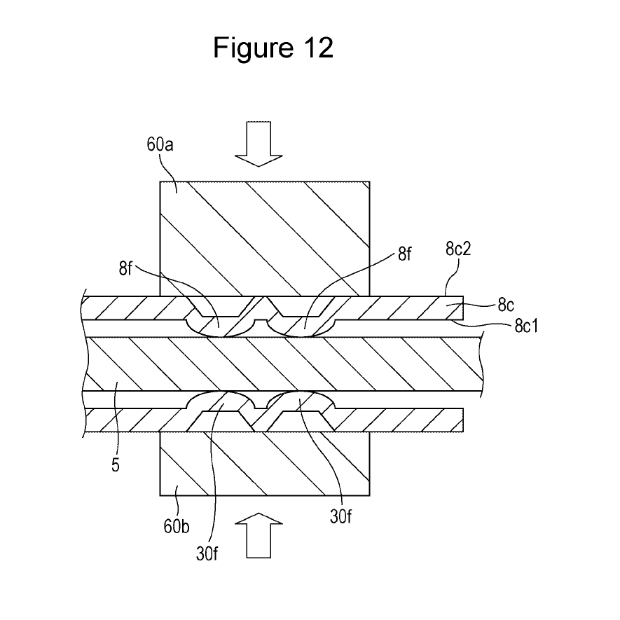

As shown in FIG. 12, the negative-electrode current collector support 30 (or the positive-electrode current collector support) can also be provided with projections 30f. The negative-electrode current collector support 30 (or the positive-electrode current collector support) provided with the projections 30f has an advantage: the concentration of current is facilitated to more efficiently form the weld nugget.

### Modification 4

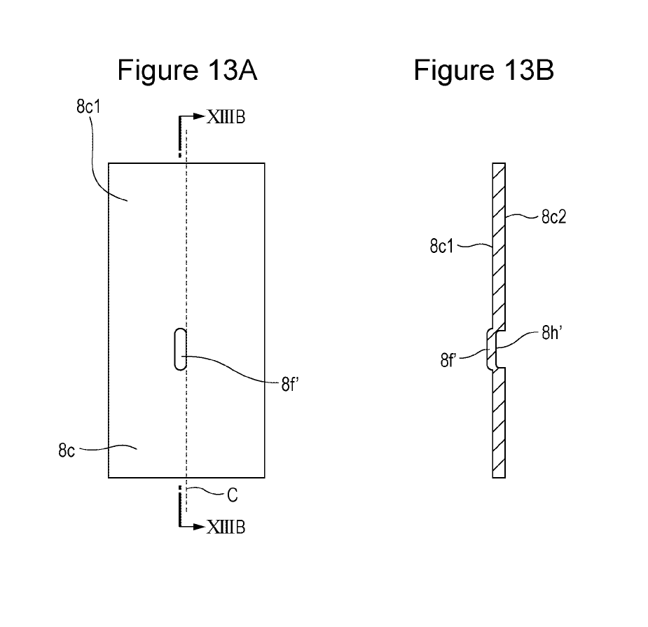

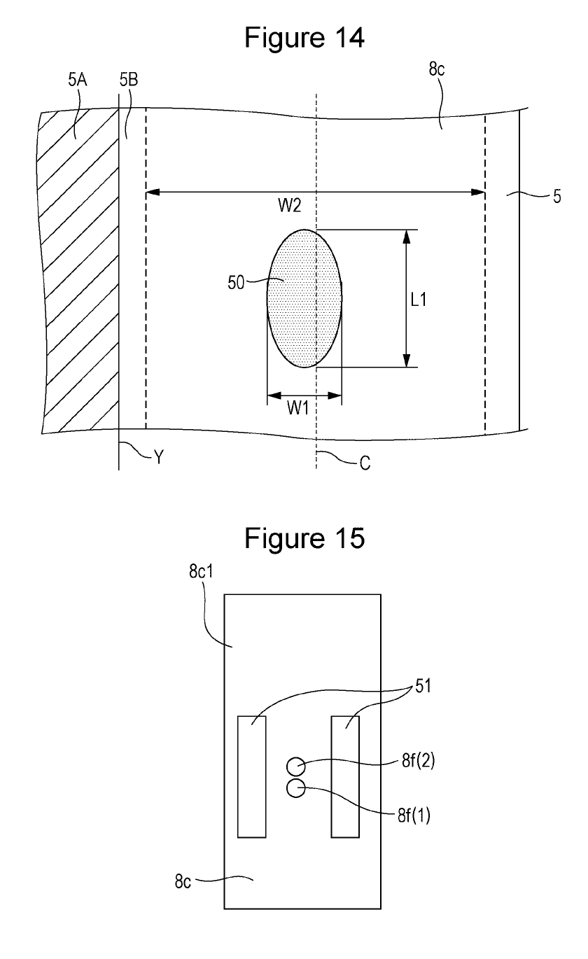

As shown in FIG. 13, an elliptic projection 8f can be formed on the connecting surface 8c1 of the negative-electrode current collector 8. Use of this negative-electrode current collector 8 enables the formation of the weld nugget 50 having an oblong section as shown in FIG. 14. With this structure, the detachment of a portion at which the current collector and the exposed core portion are welded and the breakage of a portion near the welded portion of the exposed core portion can be suppressed more than when the section of the weld nugget is perfectly circular, even though forth is applied in the direction in which the current collector is rotated about the weld nugget with respect to the exposed core portion. When the projection having an oblong shape such as an elliptic shape is formed, the direction in which the major axis of the projection extends preferably matches the direction in which the border Y extends. In this state, the length L1 of the weld nugget 50 in the direction in line with the border Y is larger than the width W1 of the weld nugget 50 in the direction perpendicular to the border Y. The length L1 and the width W1 of the weld nugget 50 preferably satisfy the relationship L1/W1≧1.5, more preferably L1/W1≧2. The width W2 of the junction 8c is preferably larger than the width W1 of the weld nugget 50. The width W1 of the weld nugget 50 and the width W2 of the junction 8c preferably satisfy the relationship W2/W1≧1.5, more preferably W2/W1≧2. A recess 8h′ is formed at a position corresponding to the projection 8f on the outer surface 8c2. The projection can be provided with a through hole also when the projection has an oblong shape, such as an elliptic shape, in plan view. The direction in which the major axis of the projection extends is preferably parallel with the border Y.

### Modification 5

As shown in FIG. 15, insulator spacers 51 can be disposed around the projections 8f on the connecting surface 8c1 of the negative-electrode current collector 8. With this structure, the current collector can be stably disposed on the exposed core portion. It is particularly preferable to dispose the insulator spacers 51 between the projections 8f and the part of the electrode body at which electricity is stored. In this case, the insulator spacers 51 can prevent molten metallic particles generated when welding from scattering on the side of the part of the electrode body at which electricity is stored. Each of the insulator spacers 51 is preferably made of a resin. Each of the insulator spacers 51 is preferably a sheet. It is particularly preferable that each of the insulator spacers 51 is a tape with an adhesive layer or a thermal adhesive tape.

### Modification 6

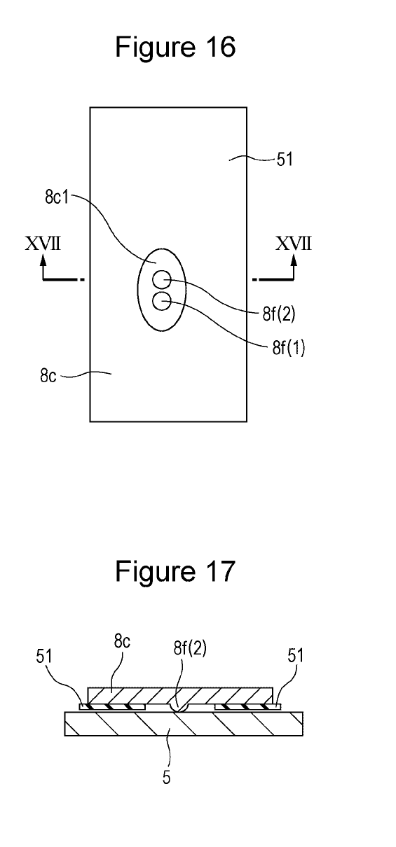

As shown in FIG. 16, the insulator spacer 51 may have an opening and the projections 8f may be located within the opening. FIG. 17 is a sectional view along the line XVII-XVII in FIG. 16.

The insulator spacer need only be disposed near the projections (portion at which the weld nugget will be formed) between the connecting surface of the current collector and the outer surface of the exposed core portion. Accordingly, the insulator spacer may be previously disposed on the outer surface of the exposed core portion.

When the current collector and the current collector support are used, it is possible that no projection is formed on the current collector but a projection is formed on the connecting surface of the current collector support facing the exposed core portion, and the current collector, the exposed core portion, and the current collector support can be subjected to resistance welding in the above manner.

### Modification 7

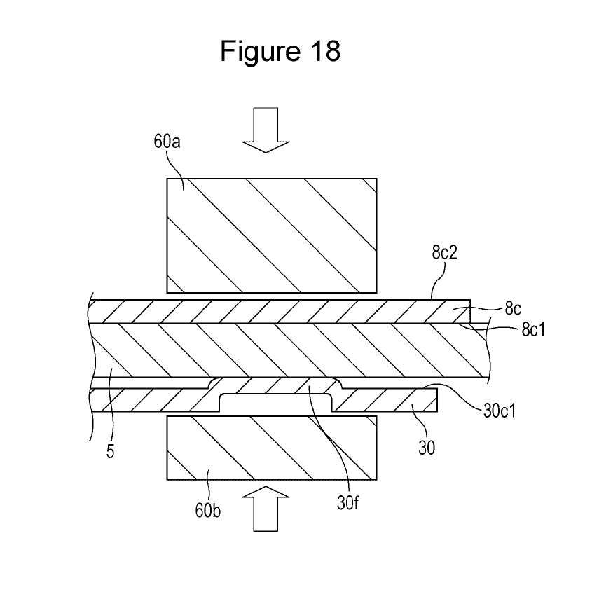

FIG. 18 shows an example in which no projection is formed on the connecting surface 8c1 of the junction 8c of the negative-electrode current collector 8 and a projection 30f is formed on the connecting surface 30c1 of the current collector support 30. In this modification, a negative-electrode current collector having the same structure as in the negative-electrode current collector 8 shown in FIG. 4 except that the projections 8f and the recesses 8h are not formed on the junction 8c. The negative-electrode current collector support 30 that is used includes the elliptic projection 30f formed on the connecting surface 30c1. Two projections can be formed on the connecting surface 30c1 of the negative-electrode current collector support 30 instead of forming the elliptic projection. The negative-electrode current collector support is preferably provided with a bent portion at its end in the width direction as well as the current collector.

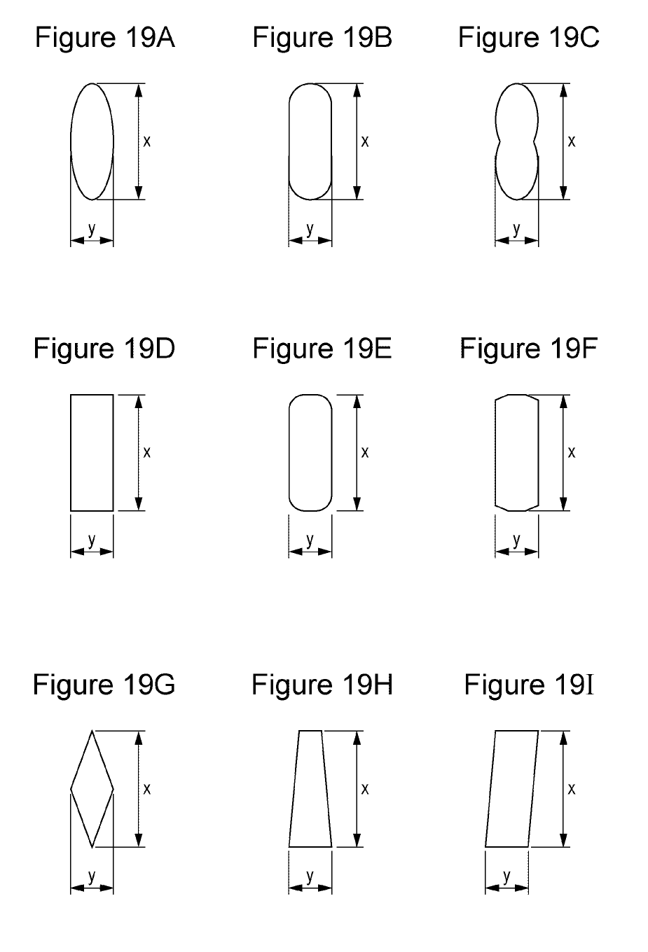

As shown in FIGS. 19A to 19I, examples of the oblong shape of the projection in plan view include an ellipse (FIG. 19A), an ellipse (FIG. 19B), a shape in which plural circles are combined (FIG. 19C), a rectangle (FIG. 19D), a rectangle with rounded corners (FIG. 19E), a rectangle with cut corners (FIG. 19F), a rhombus (FIG. 19G), a trapezoid (FIG. 19H), and a parallelogram (FIG. 19I). In these projections, the length x in the direction in which the major axis extends is larger than the length y in the direction in which the minor axis extends, in plan view.

The above embodiment and modifications can also be applied to the positive electrode side.

### Others

Although the flat electrode body is exemplified by the wound electrode body in the above embodiment, the electrode body may be a stack-type electrode body in which plural positive-electrode sheets and plural negative-electrode sheets are stacked with separators interposed therebetween. For the wound electrode body, the exposed positive-electrode-core portion and the exposed negative-electrode-core portion that are formed of the stacked layers may be located at one end in the direction in which the winging axis extends.

The method of connecting the positive-electrode current collector member and the exposed positive-electrode-core portion is not necessarily the same as the method of connecting the negative-electrode current collector member and the exposed negative-electrode-core portion. For example, it is possible to perform the resistance welding on one of the positive electrode side and the negative electrode side and perform the ultrasonic welding or laser welding on the other side.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

1. A method of producing a secondary battery,
the secondary battery including a flat electrode body including a positive-electrode sheet and a negative-electrode sheet, and a battery case containing the electrode body therein, wherein at least one of the positive-electrode sheet and the negative-electrode sheet includes a core and an active material mixture layer formed on the core, the core includes an exposed core portion at which the core is exposed, the exposed core portion is connected to a current collector member, and the current collector member includes a junction connected to the exposed core portion and a connecting surface provided on the junction such that the connecting surface faces the exposed core portion,
the method comprising:
performing resistance welding to melt a projection and the exposed core portion and form a weld nugget, while the projection is in contact with an outer surface of the exposed core portion formed of stacked layers, the projection being formed on the connecting surface of the current collector member before the current collector member is connected to the exposed core portion,
wherein a section of the weld nugget that is perpendicular to a direction in which the layers of the exposed core portion are stacked is oblong, when an area of the section of the weld nugget is at a maximum.

2. The method according to claim 1,
wherein a border between a region in which the active material mixture layer is formed and a region in which the active material mixture layer is not formed is established in the core, and
wherein a ratio of a length of the section of the weld nugget in a direction in line with the border to a width of the section of the weld nugget in a direction perpendicular to the border is 1.5 or more.

3. The method according to claim 1,
wherein a border between a region in which the active material mixture layer is formed and a region in which the active material mixture layer is not formed is established in the core, and
wherein a ratio of a width of the junction in a direction perpendicular to the border to a width of the section of the weld nugget in the direction perpendicular to the border is 1.5 or more.

4. The method according to claim 1,
wherein a shape of the projection in plan view is oblong.

5. The method according to claim 4,
wherein a border between a region in which the active material mixture layer is formed and a region in which the active material mixture layer is not formed is established in the core, and
wherein, in the step of the resistance welding, the projection is disposed such that a major axis thereof extends in a direction in line with the border.

6. The method according to claim 4,
wherein the electrode body is a wound electrode body obtained by winding the positive-electrode sheet and the negative-electrode sheet with a separator interposed therebetween, and
wherein, in the step of the resistance welding, the projection is disposed such that a major axis thereof extends in a direction perpendicular to a direction in which a winding axis of the wound electrode body extends.

7. The method according to claim 1,
wherein at least two of the projections are formed on the connecting surface, and
wherein, in the step of the resistance welding, the resistance welding is performed to melt the at least two of the projections and the exposed core portion and form the weld nugget, while the at least two of projections are in contact with the outer surface of the exposed core portion formed of the stacked layers.

8. The method according to claim 7,
wherein, in the step of the resistance welding, the at least two of the projections are arranged in a direction in line with a border between a region in which the active material mixture layer is formed and a region in which the active material mixture layer is not formed, the border being established in the core.

9. The method according to claim 7,
wherein the electrode body is a wound electrode body obtained by winding the positive-electrode sheet and the negative-electrode sheet with a separator interposed therebetween, and
wherein, in the step of the resistance welding, the at least two of the projections are arranged in a direction perpendicular to a direction in which a winding axis of the wound electrode body extends.

10. A secondary battery comprising:
a wound electrode body obtained by winding a positive-electrode sheet and a negative-electrode sheet with a separator interposed therebetween;
an exterior body that has an opening and contains the wound electrode body;
a sealing plate that seals the opening; and
a positive terminal and a negative terminal that are secured to the sealing plate,
wherein at least one of the positive-electrode sheet and the negative-electrode sheet includes a core and an active material mixture layer formed on the core,
wherein the core includes an exposed core portion at which the core is exposed,
wherein the exposed core portion is connected to a current collector member,
wherein the current collector member includes a junction connected to the exposed core portion,
wherein the current collector member is connected to an outer surface of the exposed core portion formed of stacked layers,
wherein a weld nugget is formed at the junction between the current collector member and the exposed core portion, and
wherein a section of the weld nugget that is perpendicular to a direction in which the layers of the exposed core portion are stacked is oblong, when an area of the section of the weld nugget is at a maximum, and a width of the section of the weld nugget in a direction in which a winding axis of the wound electrode body extends is smaller than a width of the junction in the direction in which the winding axis extends.

11. The secondary battery according to claim 10,
wherein a ratio of a length of the section of the weld nugget in a direction perpendicular to the direction in which the winding axis extends to a width of the section of the weld nugget in the direction in which the winding axis extends is 1.5 or more.

12. The secondary battery according to claim 10,
wherein a ratio of the width of the junction in the direction in which the winding axis extends to the width of the section of the weld nugget in the direction in which the winding axis extends is 1.5 or more.

13. The secondary battery according to claim 10,
wherein the weld nugget is formed such that a projection is formed on the current collector member before the current collector member is connected to the exposed core portion and resistance welding is performed while the projection is in contact with the exposed core portion.
